(19) United States
(12) Patent Application Publication
(10) Pub. No.: US 2025/0333819 A1
(43) Pub. Date: Oct. 30, 2025

(54) ALLOY COMPOSITION OF TITANIUM-GADOLINIUM ALLOY WITH EXCELLENT NEUTRON ABSORPTION ABILITY AND TENSILE PROPERTIES AND NEUTRON ABSORBING STRUCTURAL MATERIAL MANUFACTURED BY USING SAME

(71) Applicant: KOREA ATOMIC ENERGY RESEARCH INSTITUTE, Daejeon (KR)

(72) Inventors: Young-Bum CHUN, Sejong (KR); Sunyoung PARK, Sejong-si (KR); Ji Hoon KANG, Daejeon (KR); Young-ouk LEE, Sejong (KR)

(21) Appl. No.: 18/866,866

(22) PCT Filed: Jul. 12, 2023
(86) PCT No.: PCT/KR2023/009933

§ 371 Date: Nov. 18, 2024

(30) Foreign Application Priority Data
Jul. 19, 2022 (KR) 10-2022-0088688
Jul. 11, 2023 (KR) 10-2023-0090013

(51) Int. Cl. C22C 14/00; C22C 1/02; C22F 1/00; C22F 1/18; G21C 7/24

(52) U.S. Cl. CPC C22C 14/00; C22C 1/02; C22F 1/002; C22F 1/183; G21C 7/24

(57) ABSTRACT

According to the present invention, the neutron absorbing structural material of the present invention exhibits superior strength and ductility to those of the conventional Al-B₄C composite-based neutron absorber and exhibit superior ductility, and thus not only has a neutron absorption function but also functions as a neutron absorbing structural material that itself has performance as a structural material. Furthermore, problems, such as poor formability of boron-containing corrosion-resistant steel in a manufacturing process and high brittleness of finished products, are improved and at the same time, a separate support or structural material is not required, thus remarkably improving the efficiency of design and construction of spent nuclear fuel storage facilities and the economic efficiency of construction, and it is possible to design a spent nuclear fuel storage container with a certain volume so as to store a larger amount of spent nuclear fuel therein, thus maximizing usability in a limited space.

### CROSS REFERENCE TO RELATED APPLICATION

This application is a National Stage of International Application No. PCT/KR2023/009933, filed on Jul. 12, 2023, which is based upon and claims priority to Korean Patent Application No. 10-2022-0088688, filed on Jul. 19, 2022, and Korean Patent Application No. 10-2023-0090013, filed on Jul. 11, 2023, in the Korea Intellectual Property Office. All of the aforementioned applications are hereby incorporated by reference in their entireties.

### TECHNICAL FIELD

The present invention relates to a titanium-gadolinium-based alloy composition of a neutron-absorbing structural material having excellent neutron absorption ability and tensile properties, and a neutron absorbing structural material manufactured using the same. More specifically, the present invention relates to an alloy composition of a neutron absorbing structural material having excellent mechanical strength, ductility, and neutron absorption ability compared to existing commercial Al-B₄C composites or boron-containing corrosion-resistant steel, and a neutron absorbing structural material manufactured using the same.

### BACKGROUND ART

Spent nuclear fuel, which is generated when nuclear fuel is used to generate electric power in a nuclear power plant and then disposed, is stored in wet or dry storage facilities until it reaches the final disposal stage, and in this process, the spent nuclear fuel undergoes cooling and radioactive decay. During the storage and transport processes of spent nuclear fuel, neutron absorbers are installed between bundles of spent nuclear fuel to prevent the multiplication of neutrons due to the fission reaction of radioactive nuclides remaining in the spent nuclear fuel and the resulting criticality. At this time, the neutron poisons contained in the neutron absorbers absorb neutrons with various levels of energy, maintaining the subcriticality of the spent nuclear fuel storage system. Well-known neutron poisons include boron (B), gadolinium (Gd), cadmium (Cd), indium (In), hafnium (Hf), and samarium (Sm).

Meanwhile, in the spent nuclear fuel storage industry, for the efficient storage of spent nuclear fuel and the efficient design and production of spent nuclear fuel storage systems, interest is focused on the development of so-called neutron absorbing structural materials that have structural performance as well as neutron-absorbing performance. In other words, when a neutron absorbing material is capable of serving as a structural material in addition to having neutron absorption ability, separate supports or structural materials are not required, and thus the efficiency and economic feasibility of designing and manufacturing spent nuclear fuel storage facilities may be increased, and in some cases, it is possible to design a spent nuclear fuel storage container with a certain volume so as to store a larger amount of spent nuclear fuel therein, thus maximizing usability in a limited space.

However, the neutron poisons and composites prepared using the same that have been used in neutron absorbing structural materials studied to date have limitations in their use as neutron absorbing structural materials that have not only neutron absorption ability but also performance as structural materials due to the following problems.

First, Al-B₄C composites (or Al-B₄C cermets), conventionally used as neutron absorbers, are prepared in the form of plates through a powder metallurgy process and used, but they have low strength and high brittleness, making it difficult to use them as a neutron absorbing structural material. In other words, since Al-B₄C composites have highly brittle B₄C particles dispersed at a high fraction within the matrix metal, they have a problem of a decrease in the structural stability of the composite or are very vulnerable to impact or damage. Accordingly, when the volume fraction of B₄C particles is reduced to lower the brittleness, there is also a problem that the neutron absorption ability is lowered, making it difficult to achieve the original purpose of a neutron absorber. As a result, the conventionally used Al-B₄C composites require a separate structural material, and this limits maximizing the above-described space utilization.

Second, although research on new additive substances or materials is

being conducted to improve the low strength of Al-B₄C composites, no research has been reported on a structural material that has excellent neutron absorption ability, high strength, and high ductility and satisfies both the efficiency and economic feasibility of designing and manufacturing spent nuclear fuel storage facilities. More specifically, there have been attempts to use high-strength Al alloy powder (Al 3000, 5000, and 6000 series alloys) in addition to pure aluminum powder in Al-B₄C composites, but in this case, there is a problem that it is difficult to manufacture it into a plate because the strength of the Al alloy matrix is too high when a large amount of B₄C is added. In addition, although boron-containing corrosion-resistant steel (borated stainless steel (BSS), ASTM A887-20, Grade A), which is manufactured by adding up to 2.25% by weight of boron (B) to the 304 alloy, an austenitic corrosion-resistant steel, through powder metallurgy, has been commercialized and used, since it is manufactured based on powder metallurgy, the manufacturing cost is relatively high, which poses a disadvantage in terms of the efficiency and economic feasibility of designing and manufacturing spent nuclear fuel storage facilities.

Third, as a part of an effort to replace the conventional Al-B₄C composite and to improve the economic feasibility of the austenitic corrosion-resistant steel 304 alloy, a material (ASTM A887-20, Grade B) manufactured through a wrought process such as casting/rolling rather than powder metallurgy has been commercialized. Although this may be advantageous in economic aspects, it has a problem of producing a large amount of brittle (Fe,Cr)₂B compounds, making it difficult to hot-process into a plate shape, and it also exhibits very low ductility and impact toughness after manufacturing. In addition, due to the presence of (Fe,Cr)₂B compounds with a high volume fraction, the weldability for manufacturing a basket (a rectangular tube shape) for storing spent nuclear fuel is also poor, and furthermore, since the amount of boron that may be added is limited, there is a problem that criticality control performance is low.

Accordingly, there is an urgent need for research on a new material that can improve the problems of boron-containing corrosion-resistant steel, such as poor formability in the manufacturing process and high brittleness of finished products, and at the same time solve the problems of strength and brittleness of Al-B₄C composites, while having a certain level of neutron absorption ability or higher, so that it can serve as both a neutron absorber and a structural material.

### DISCLOSURE

### Technical Problem

The present invention has been devised to overcome the above-described problems, and the problem to be solved by the present invention is to provide a neutron absorbing structural material alloy composition and a neutron absorbing structural material according to the composition, which may improve the low strength of the conventional Al-B₄C composite-based neutron absorbing material and exhibit superior ductility, thereby serving as a neutron absorbing structural material that has not only a neutron absorbing function but also the performance of a structural material.

In addition, the problem to be solved by the present invention is to provide a neutron absorbing structural material alloy composition and a neutron absorbing structural material according to the composition, which may improve the problems of poor formability in the manufacturing process of boron-containing corrosion-resistant steel and high brittleness of finished products, and at the same time, remarkably improve the efficiency and economic feasibility of designing and manufacturing spent nuclear fuel storage facilities by not requiring a separate support or structural material, and enable the design of a spent nuclear fuel storage container with a certain volume so as to store a larger amount of spent nuclear fuel therein, thus maximizing usability in a limited space.

### Technical Solution

To solve the above-described problems, the present invention provides a neutron absorbing structural material alloy composition including a matrix metal; and gadolinium (Gd) in an amount of 2% to 49% by weight based on the total weight of the matrix metal.

In addition, the matrix metal may be titanium.

In addition, the neutron absorbing structural material alloy composition may contain no hafnium (Hf).

The present invention provides a neutron absorbing structural material including: the above-described neutron absorbing structural material alloy composition; and a residual amount of oxygen; and a part of the gadolinium of the neutron absorbing structural material alloy composition is dissolved in a matrix metal, and the remaining part may be dispersed in the form of an α-gadolinium phase (α-Gd phase).

In addition, the residual amount of oxygen may be less than 0.3% by weight based on the total weight of the neutron absorbing structural material.

In addition, the neutron absorbing structural material may satisfy all of Relations 1 to 3 below:

(1) yield strength of less than 550 MPa;

(2) maximum tensile strength of less than 650 MPa; and

(3) total elongation of 22% or more.

In addition, the present invention provides a method of manufacturing a

neutron absorbing structural material, including a first step of preparing the above-described neutron absorbing structural material alloy composition; a second step of melting the neutron absorbing structural material alloy composition to manufacture a molten ingot; a third step of hot-forging the molten ingot and then rolling the same to manufacture a rolled material; and a fourth step of heat-treating the rolled material.

In addition, the fourth step may be a β-phase heat treatment step of performing heat treatment at a temperature higher than or equal to 900° C. and then air-cooling or water-cooling, or a recrystallization heat treatment step at a temperature lower than or equal to 900° C.

### Advantageous Effects

The present invention can improve the low strength of the conventional Al-B₄C composite-based neutron absorbing material and exhibit superior ductility, thereby serving as a neutron absorbing structural material that has not only a neutron absorbing function but also the performance of a structural material. In addition, the present invention can improve the problems of poor formability in the manufacturing process of boron-containing corrosion-resistant steel and high brittleness of finished products, and at the same time, remarkably improve the efficiency and economic feasibility of designing and manufacturing spent nuclear fuel storage facilities by not requiring a separate support or structural material, and enable the design of a spent nuclear fuel storage container with a certain volume so as to store a larger amount of spent nuclear fuel therein, thus maximizing usability in a limited space.

### DESCRIPTION OF DRAWINGS

FIG. 1 shows a graph illustrating the neutron absorption ability of a neutron absorbing structural material according to one embodiment of the present invention.

FIG. 2 shows a graph illustrating a room temperature tensile test curve of a neutron absorbing structural material according to one embodiment of the present invention.

FIGS. 3 and 4 show low-magnification and high-magnification microstructure images of a neutron absorbing structural material according to one embodiment of the present invention, respectively.

FIG. 5 shows a microstructure image illustrating the crystal orientation spatial distribution of a neutron absorbing structural material according to one embodiment of the present invention.

### MODES OF THE INVENTION

Hereinafter, embodiments of the present invention will be described in detail so that those skilled in the art may easily implement the present invention. The present invention may be implemented in various different forms and is not limited to the embodiments described herein.

There is little research on neutron poisons and composites using them that can improve the problems of poor formability in the manufacturing process of boron-containing corrosion-resistant steel or Al-B₄C composites used in conventional spent nuclear fuel storage facilities and the high brittleness and low strength of finished products, and that can both exhibit neutron absorption ability and serve as a structural material, so there are limitations in improving the efficiency and economic feasibility of designing and manufacturing spent nuclear fuel storage facilities and maximizing usability in the limited space of a spent nuclear fuel storage container.

Accordingly, the present invention seeks to solve the above-described problems by providing a neutron absorbing structural material alloy composition containing a matrix metal and 2% to 49% by weight of gadolinium (Gd) based on the total weight of the matrix metal.

Through this, the present invention can improve the low strength of a conventional Al-B₄C composite-based neutron absorber and exhibit superior ductility, and thus not only has a neutron absorption function but also functions as a neutron absorbing structural material that has performance as a structural material. In addition, problems, such as poor formability of boron-containing corrosion-resistant steel in a manufacturing process and high brittleness of finished products, are improved and at the same time, a separate support or structural material is not required, thus remarkably improving the efficiency and economic efficiency of designing and manufacturing spent nuclear fuel storage facilities, and it is possible to design a spent nuclear fuel storage container with a certain volume so as to store a larger amount of spent nuclear fuel therein, thus maximizing usability in a limited space.

Hereinafter, a neutron absorbing structural material according to the present invention will be described in detail.

The present invention, which is applied to a spent nuclear fuel storage system, is manufactured in a plate shape and manufactured and installed in a rectangular tube shape that surrounds a spent nuclear fuel bundle, and it is necessary to lower the criticality of the spent nuclear fuel to 0.95 or less by absorbing neutrons emitted from the spent nuclear fuel. In addition, in the spent nuclear fuel storage industry to which the present invention pertains, interest is focused on the development of so-called neutron absorbing structural materials that have structural performance as well as neutron-absorbing performance for efficient storage of spent nuclear fuel and efficient design and manufacture of a spent nuclear fuel storage system. When a neutron absorbing material is capable of serving as a structural material in addition to having neutron absorption ability, separate supports or structural materials are not required, and thus the efficiency and economic efficiency of designing and manufacturing spent nuclear fuel storage facilities may be increased, and in some cases, it is possible to design a spent nuclear fuel storage container with a certain volume so as to store a larger amount of spent nuclear fuel therein, thus maximizing usability in a limited space. Therefore, the material to be developed in the present invention is a neutron absorbing structural material that can both serve as a structural material and exhibit an excellent level of neutron absorption ability to lower the criticality within a spent nuclear fuel storage system to 0.95 or less.

Accordingly, a neutron absorbing structural material alloy composition according to the present invention includes a matrix metal and a large amount of gadolinium (Gd) added to the matrix metal.

The neutron absorbing structural material of the present invention serves as both a structure supporting spent nuclear fuel and a criticality controller to suppress nuclear reactions, and effectively releases the decay heat released from the spent nuclear fuel to the outside, thereby improving thermal stability by suppressing the temperature rise of the spent nuclear fuel.

To this end, the matrix metal may be a metal having excellent corrosion resistance and specific strength sufficient to serve as a structural material, and most preferably, titanium (Ti) may be used.

Meanwhile, boron, which is generally dispersed in a matrix metal for neutron absorption, is a representative neutron poison used for neutron absorption in the nuclear industry. Naturally existing boron is composed of two isotopes, ¹⁰B and ¹¹B, at about 19.9% and 80.1%, and among them, ¹⁰B is used as a neutron poison because it exhibits a high neutron absorption cross-section.

However, conventional Al-B₄C composites (or Al-B₄C cermets) containing the boron particles (¹⁰B) generally have low strength and high brittleness because they contain a high fraction of B₄C particles, making them unsuitable for use as a structural material. In addition, besides pure Al powder, high-strength Al alloy powder (Al 3000, 5000, and 6000 series alloys) is also used to improve the strength of Al-B₄C composites. However, in this case, there is a problem that it is difficult to manufacture it into a plate material when a large amount of B₄C is added because the strength of the Al alloy matrix is high.

Accordingly, by using gadolinium for neutron absorption purposes, unlike the existing Al-B₄C composite material containing boron, a neutron absorbing structural material according to the present invention can solve the problem of B₄C brittleness and the plate forming problem resulting from high strength.

The gadolinium is an element used as a neutron poison in the nuclear industry due to its high neutron absorption ability, like boron (B), cadmium (Cd), indium (In), hafnium (Hf), and samarium (Sm). In other words, boron, which is used as a neutron poison in most commercial neutron absorbers such as corrosion-resistant steel containing boron and Al-B₄C composites, has a thermal neutron absorption cross-section of 767 barn, while gadolinium has a thermal neutron absorption cross-section of 49,700 barn, which is about 64 times higher. Therefore, the present invention can achieve a neutron absorption ability that is significantly superior to boron even by adding a small amount of gadolinium.

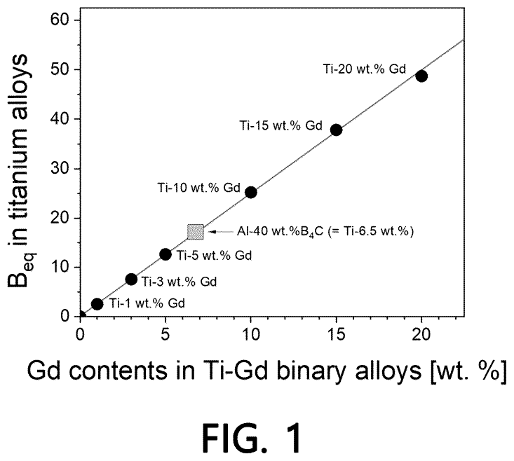

More specifically, referring to FIG. 1, which shows the neutron absorption ability of neutron absorbing structural materials manufactured according to the titanium-gadolinium neutron absorbing structural material alloy composition prepared by using titanium as the matrix metal and adding gadolinium to titanium in different contents according to a preferred embodiment of the present invention, it can be seen that the examples of neutron absorbing structural materials according to the present invention exhibit superior neutron absorption ability compared to the commercial neutron absorbing materials such as Al-B₄C composites and boron-containing corrosion-resistant steel. In other words, when the neutron absorption ability according to the gadolinium content of the titanium-gadolinium alloy is calculated based on the boron equivalent (B_{eq}) using the following Mathematical Formula 1 and compared with the Al-B₄C composite and boron-containing corrosion-resistant steel, which are commercial neutron absorbers, it can be seen that when 6.5% by weight or more of gadolinium is added to titanium, the neutron absorption ability is superior to that of the Al-40 wt. % B₄C composite, which has the highest neutron absorption ability among commercial neutron absorbers. In other words, it can be seen that Example 4 has superior neutron absorption ability to that of the Al-40 wt. % B₄C composite.

$${B}_{eq} = 2.5 \; 32 \times Gd \% by weight \qquad [ Mathematical Formula 1 ]$$

To this end, in a neutron-absorbing structural material alloy composition according to the present invention, the gadolinium may be contained in an amount of 2% to 49% by weight, preferably 4% to 20% by weight, and most preferably 6% to 20% by weight based on the total weight. In this case, when the gadolinium is contained in an amount of less than 2% by weight based on the total weight in the neutron absorbing structural material alloy composition according to the present invention, there may be a problem that the neutron absorption ability is reduced due to a lack of gadolinium, and in addition, when the gadolinium is contained in an amount of more than 20% by weight based on the total weight in the neutron absorbing structural material alloy composition according to the present invention, the neutron absorption ability may be excellent, but the corrosion resistance and oxidation resistance may be reduced, and moreover, there may be a problem that the price of the raw materials increases. In other words, in the present invention, a neutron absorbing structural material with a gadolinium content exceeding 20% by weight may also be manufactured, but since sufficiently excellent neutron absorption ability may be exhibited even with an addition of 20% by weight, there is no need to add more gadolinium in a general spent nuclear fuel storage facility, but it can be appropriately selected depending on the intended use and environment.

Meanwhile, there are cases where hafnium (Hf) is further added, but the neutron absorption cross-sectional area of hafnium is 104 barn, which is only 1/477 of the neutron absorption cross-sectional area of gadolinium (49,700 barn), so the improvement in neutron absorption ability through the addition of hafnium is negligible, and the addition of hafnium increases the strength of the matrix metal but reduces its ductility, so it does not conform to the purpose of the present invention to develop a neutron absorbing structural material with excellent ductility and formability, and there is also the problem of rapidly increasing the manufacturing costs because hafnium is an expensive alloying element. Therefore, a neutron absorbing structural material alloy composition according to the present invention may not further include hafnium.

In addition, as described above, the present invention may ensure excellent neutron absorption ability by adding gadolinium, and at the same time, the added gadolinium may react with oxygen remaining in the matrix metal to lower the oxygen content in the matrix metal, thereby improving the ductility of the matrix metal.

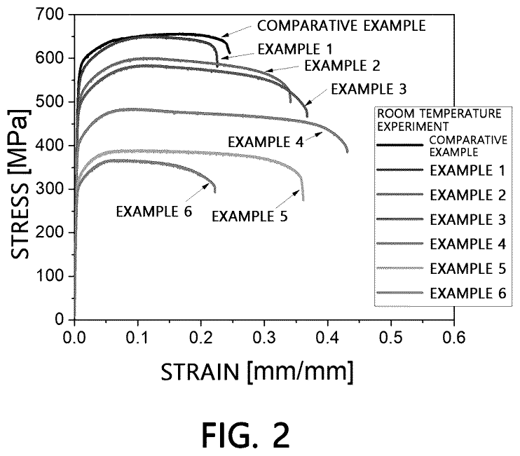

More specifically, referring to Table 2, which shows the tensile test results of a neutron absorbing structural material manufactured according to the titanium-gadolinium neutron absorbing structural material alloy composition prepared by using titanium as the matrix metal and adding gadolinium to titanium in different contents according to a preferred embodiment of the present invention, and FIG. 2, which shows a room temperature tensile test curve, it can be seen that while the strength generally increases and the ductility decreases as the alloy element is added, the alloy prepared through the alloy composition and heat treatment process suggested by the present invention exhibits the opposite pattern when gadolinium is added up to 10% by weight. In other words, a comparative example prepared by adding no gadolinium exhibited a yield strength of 550 MPa and a total elongation of 23.8%, whereas the examples prepared by adding gadolinium up to 10% by weight exhibited decreased strength and increased elongation as the amount of added gadolinium increased. For example, in Example 4, the yield strength decreased to 395 MPa and the total elongation increased to 42.6% compared to the comparative material.

There are two reasons why the strength of the neutron absorbing structural material decreases and the ductility increases as the amount of added gadolinium increases. One is that the lath-shaped martensitic transformation is suppressed when cooling in the high temperature β-phase region as the amount of added gadolinium increases. Another reason is that the gadolinium α-phase present as a second phase absorbs oxygen present as an interstitial element in the titanium α-phase, which is the matrix structure, and forms a thin gadolinium oxide (Gd₂O₃) on the surface of the gadolinium α-phase, thereby lowering the oxygen concentration in the titanium α-phase.

In addition, even when the yield strength decreased with the increase in the amount of added gadolinium, all examples exhibited higher strength and elongation than those of the conventional boron-containing corrosion-resistant steel (UNS S30467, Type 304B7, Grade B: 1.75% to 2.25% by weight), which is a commercial neutron absorbing structural material exhibiting a yield strength of about 205 MPa and a total elongation of 6%.

As described above, since the present invention can improve the low strength of the conventional Al-B₄C composite-based neutron absorber and exhibit superior ductility, it can simultaneously perform the function of a neutron absorbing structural material as well as the neutron absorption function. In addition, it can improve the problems of poor formability in the manufacturing process of boron-containing corrosion-resistant steel and high brittleness of finished products, and at the same time, remarkably improve the efficiency and economic efficiency of designing and manufacturing spent nuclear fuel storage facilities by not requiring a separate support or structural material, and enable the design of a spent nuclear fuel storage container with a certain volume so as to store a larger amount of spent nuclear fuel therein, thus maximizing usability in a limited space.

Next, a neutron absorbing structural material according to the present invention will be described. However, in order to avoid redundancy, descriptions of parts with technical concepts identical to the above-described neutron absorbing structural material alloy composition will be omitted.

The neutron absorbing structural material according to the present invention includes the above-described neutron absorbing structural material alloy composition and a residual amount of oxygen, and includes 2% to 49% by weight of gadolinium based on the total weight of the matrix metal.

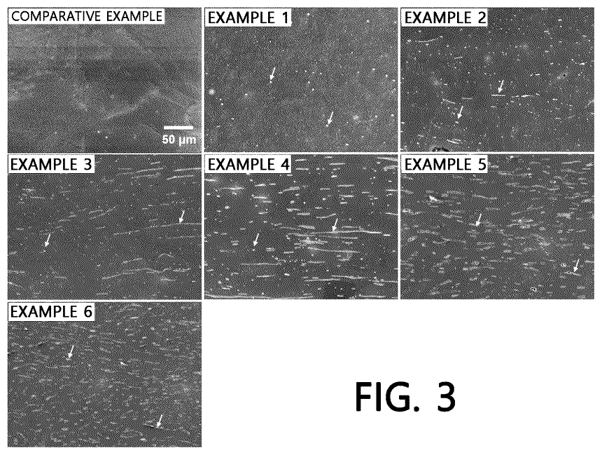

More specifically, referring to FIG. 3, which shows low-magnification microstructure images of a neutron-absorbing structural material according to preferred embodiments of the present invention, the white spherical or elongated particles indicated by arrows represent gadolinium particles, and it can be seen that gadolinium oxide (Gd₂O₃) is formed on the surface and part of the particles. In other words, since it can be seen that the fraction of such (Gd+Gd₂O₃) composite particles increases as the amount of added gadolinium increases, through the above-described results shown in FIGS. 1 and 2 and Tables 1 and 2, it can be seen that the increase in the fraction of such composite particles and the decrease in the oxygen content in the titanium matrix metal therethrough enable the present invention to exhibit excellent elongation.

To exhibit such ductility, the residual amount of oxygen may be included in an amount less than 0.3% by weight, and more preferably less than 0.2% by weight, based on the total weight of the neutron absorbing structural material. At this time, when the residual amount of oxygen exceeds 0.3% by weight based on the total weight of the neutron absorbing structural material, the strength increases but the ductility decreases, and there may be a problem that the formability in the forging, hot rolling, and cold rolling processes may decrease.

Accordingly, a neutron absorbing structural material according to the present invention may satisfy all of Relations 1 to 3 below:

(1) yield strength of less than 550 MPa;

(2) maximum tensile strength of less than 650 MPa; and

(3) total elongation of 22% or more.

Next, a method of manufacturing a neutron absorbing structural material

according to the present invention will be described. However, in order to avoid redundancy, descriptions of parts with technical concepts identical to the above-described neutron absorbing structural material will be omitted.

A method of manufacturing a neutron absorbing structural material according to the present invention includes: a first step of preparing the above-described neutron absorbing structural material alloy composition; a second step of melting the neutron absorbing structural material alloy composition to manufacture a molten ingot; a third step of hot-forging the molten ingot and then rolling the same to manufacture a rolled material; and a fourth step of heat-treating the rolled material.

The first step is a step of preparing a neutron absorbing structural material alloy composition containing a matrix metal and 2% to 49% by weight of gadolinium (Gd) based on the total weight of the matrix metal.

The matrix metal may be a metal having excellent corrosion resistance and specific strength sufficient to perform the function of a structural material, and most preferably, titanium (Ti) may be used.

Next, the second step is a step of first melting the neutron absorbing

structural material alloy composition prepared in the first step to manufacture a molten ingot.

As a method of melting the neutron absorbing structural material alloy composition, various methods widely used for melting titanium alloys among conventional matrix metals known in the art may be used as long as they are suitable for the purpose of the present invention, but preferably, vacuum plasma melting, vacuum arc melting, vacuum electron beam melting, and the like may be used. According to a preferred embodiment of the present invention, the melting may be performed by re-melting 3 to 10 times using vacuum plasma melting to manufacture a molten ingot.

The third step is a step of hot-forging the molten ingot and then rolling the

same to manufacture a rolled material. In other words, the third step includes a step of hot-forging the molten ingot and a step of manufacturing a rolled material by hot-rolling the hot-forged material, cold-rolling the hot forged material, or hot-rolling and then cold-rolling the hot forged material.

The hot forging, hot rolling, or cold rolling may be performed by a known conventional hot-forging, hot-rolling or cold-rolling process as long as it is suitable for the purpose of the present invention. For example, after heat-treating at 900 to 1200° C. for 0.5 to 4 hours, hot forging may be performed with a thickness reduction rate of 40% to 80%. Thereafter, the hot-forged material may be heat-treated at 1000 to 1200° C. for 0.5to 2 hours, and then hot rolling may be performed so that the final thickness reduction rate becomes 30% to 70%, thereby manufacturing a rolled material. At this time, it is advantageous in terms of hot-rollability to maintain the temperature of the target material so that it does not fall below 900° C. during hot-rolling. When the temperature of the material falls below this temperature during the hot-rolling process, hot rolling may be performed after maintaining the temperature at 1100° C. for 20 minutes, and water cooling may be performed after hot rolling.

Meanwhile, a hot-forged material may be manufactured into plates through cold rolling instead of hot rolling, and at this time, the hot-forged material may be manufactured into a rolled material by cold-rolling at room temperature with a final thickness reduction rate of 20% to 50%. In addition, further cold rolling may be performed on a hot-rolled plate, and when cold-rolling a hot-rolled plate, cold rolling may be performed at room temperature with a thickness reduction rate of 10% to 30%.

Next, the fourth step is a β-phase heat treatment process of performing heat treatment at a temperature of 900° C. or higher and then air cooling or water cooling, or a recrystallization heat treatment process at a temperature of 900° C. or lower.

The heat treatment of the fourth step may be a β-phase heat treatment process performed at 900 to 1100° C. for 0.5 to 2 hours. When sufficient strain energy to cause recrystallization through the above-described hot rolling or cold rolling has been accumulated in a rolled material, the recrystallization heat treatment in the α-phase region below 900° C. may be utilized as the final heat treatment.

In other words, after the first step, hot forging, hot rolling, cold rolling, and the like may all be utilized as subsequent forming processes for the molten ingot, and when needed, intermediate heat treatment may also be performed between these processes.

Hereinafter, the present invention will be described in more detail through examples. However, the following examples do not limit the scope of the present invention, and should be interpreted as helping to understand the present invention.

### EXAMPLE 1

### Manufacture of Neutron Absorbing Structural Material

After preparing a neutron-absorbing structural material alloy composition having the composition shown in Table 1 below, the composition was re-melted six times using vacuum plasma melting to manufacture an ingot. Thereafter, the molten ingot was heat-treated at 1150° C. for two hours, hot-forged with a thickness reduction rate of 70%, and water-cooled after the forging.

Next, the hot-forged material was heat-treated at 1100° C. for one hour, and then immediately hot-rolled with a final thickness reduction rate of 60%. During the hot rolling, the temperature of the target material was maintained so as not to fall below 900° C., and when the temperature of the material fell below this temperature during the hot rolling process, the temperature was maintained again at 1100° C. for 20 minutes to perform hot rolling, and then water cooling was performed after the hot rolling.

Thereafter, the hot-rolled material was heat-treated at 1000° C. for one hour, and then air-cooled.

### EXAMPLES 2 TO 6

### Manufacture of Neutron Absorbing Structural Material

Neutron absorbing structural materials were manufactured in the same manner as in Example 1, except that the composition of the neutron absorbing structural material alloy was changed as shown in Table 1 below.

### COMPARATIVE EXAMPLE

A neutron absorbing structural material having the composition shown in

Table 1 below was manufactured in the same manner as in Example 1, except that gadolinium was not added.

TABLE 1

| Classification | |
|---|---|
| | Residual amount |
| Alloying element | (analysis value) |

Element

| | | Gd target value | | |
|---|---|---|---|---|
| | Ti | (analysis value) | O | N |
| Example 1 | Bal. | 1.0 (0.99) | 0.113 | <0.001 |
| Example 2 | Bal. | 3.0 (2.97) | 0.090 | <0.001 |
| Example 3 | Bal. | 5.0 (4.81) | 0.094 | <0.001 |
| Example 4 | Bal. | 10.0 (9.68) | 0.100 | <0.001 |
| Example 5 | Bal. | 15.0 (14.77) | 0.110 | <0.001 |
| Example 6 | Bal. | 20.0 (19.24) | 0.103 | <0.001 |
| Comparative | Bal. | — | 0.104 | <0.001 |
| Example | | | | |

### EXPERIMENTAL EXAMPLE 1

### Evaluation of Neutron Absorption Ability

The neutron absorption ability of Examples 1 to 6 and Comparative Example was evaluated and shown in FIG. 1. At this time, the black circles in FIG. 1 represent the amount of Gd added in the examples and the corresponding boron equivalent, and the gray square represents the boron equivalent of the Al-40 wt. % B4C composite, which is a commercial neutron absorber (Ti-6.5 wt. % alloy has the same boron equivalent).

Referring to FIG. 1, it can be seen that the examples of the neutron absorbing structural materials according to the present invention exhibited superior neutron absorption ability compared to the Al-40 wt. % B₄C composite, which is a commercial neutron absorbing material. In other words, when the neutron absorption ability according to the gadolinium content in the titanium-gadolinium alloy was calculated based on the boron equivalent (B_{eq}) using Mathematical Formula 1 below and compared with the Al-40 wt. % B₄C composite, which is a commercial neutron absorbing material, it can be seen that when 6.5% by weight or more of gadolinium was added to titanium, the neutron absorption ability was superior to that of the Al-40 wt. % B₄C composite, which has the highest neutron absorption ability among commercial neutron absorbing materials. In other words, Examples 4, 5, and 6 exhibited superior neutron absorption ability compared to the Al-40 wt. % B₄C composite.

$${B}_{eq} = 2.5 \; 32 \times Gd \% by weight \qquad [ Mathematical Formula 1 ]$$

### EXPERIMENTAL EXAMPLE 2

### Evaluation of Tensile Properties

The tensile properties of Examples 1 to 6 and Comparative Example were evaluated, and the results are shown in FIG. 2 and Table 2.

TABLE 2

| | Yield | Ultimate | Uniform | Total |
|---|---|---|---|---|
| | strength | tensile | elongation | elongation |
| | [MPa] | strength [MPa] | [%] | [%] |
| Example 1 | 531 | 650 | 12.3 | 21.9 |
| Example 2 | 484 | 559 | 11.7 | 33.4 |
| Example 3 | 475 | 583 | 11.5 | 36.1 |
| Example 4 | 395 | 483 | 9.3 | 42.6 |
| Example 5 | 313 | 388 | 10.3 | 35.9 |
| Example 6 | 299 | 366 | 6.1 | 22.2 |
| Comparative | 550 | 656 | 16.6 | 23.8 |
| Example | | | | |

Referring to Table 2 above and the room temperature tensile test curve of FIG. 2, it can be seen that generally, as an alloying element is added, the strength increases and ductility decreases, but the alloy prepared through the alloy composition and heat treatment process suggested in the present invention exhibited the opposite pattern. In other words, the comparative example in which gadolinium was not added exhibited a yield strength of 550 MPa and a total elongation of 23.8%, whereas in the examples in which gadolinium was added, the strength decreased and the elongation increased as the amount of added gadolinium increased up to 10% by weight. For example, in Example 4, the yield strength decreased to 395 MPa and the total elongation increased to 42.6% compared to the comparative material. However, when the amount of added gadolinium was further increased as in Examples 5 and 6, the neutron absorption ability increased proportionally, but the strength and elongation decreased again.

### EXPERIMENTAL EXAMPLE 3

### Low-Magnification and High-Magnification Images

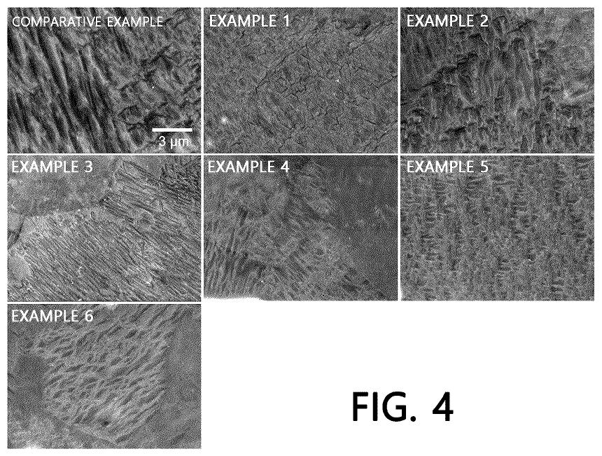

Low-magnification and high-magnification microstructure images of Examples 1 to 6 and Comparative Example were measured, and the results are shown in FIGS. 3 and 4, respectively.

Referring to FIG. 3, the white spherical or elongated particles indicated by arrows represent gadolinium particles, and gadolinium oxide (Gd₂O₃) was formed on the surface and part of the particles. The formation of an oxide on the surface of the gadolinium particles means that oxygen in the titanium matrix was absorbed by the gadolinium surface, and the fraction of such (Gd+Gd₂O₃) composite particles increased as the amount of added gadolinium increased.

FIG. 4 shows high-magnification microstructure images observed with a scanning electron microscope, in which irregularities due to defects such as low-angle grain boundaries and dislocations after chemical etching are observed on the surface. From the directionality of the irregularities, it can be seen that defects were formed and aligned in a specific direction inside a given particle.

### EXPERIMENTAL EXAMPLE 4

### Low-Magnification Crystal Orientation Spatial Distribution Microstructure Image

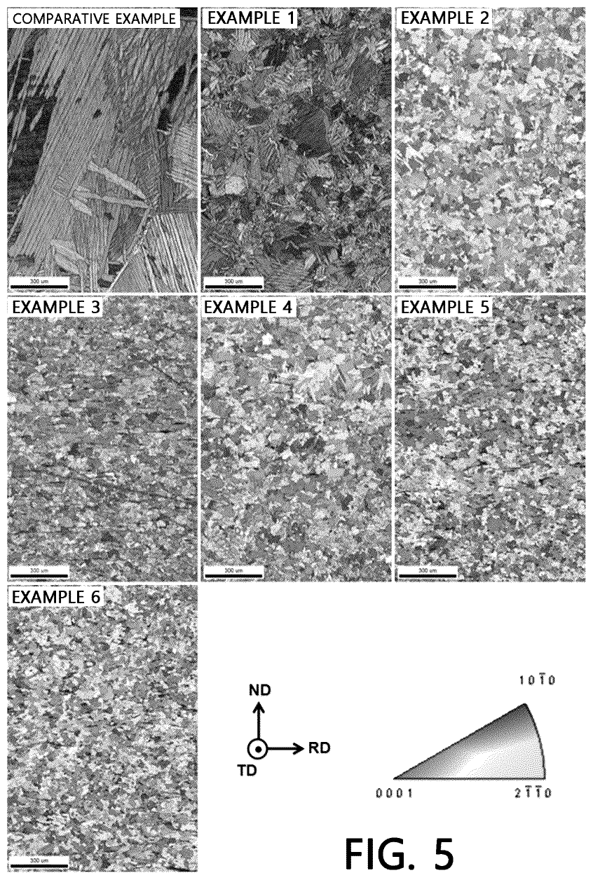

Crystal orientation spatial distribution microstructure images of Examples 1 to 6 and Comparative Example were measured using an electron backscattering diffraction method, and the results are shown in FIG. 5. In the case of pure titanium (Comparative Example) without gadolinium addition, a titanium α-phase transformed into a needle-like shape was generated during the cooling process in the titanium β-phase region. In the case of Example 1 in which 1% by weight of gadolinium was added, a needle-like α-phase was also generated, but the transformed needle-like α-phase became finer because the size of the titanium β-phase, which is a stable phase at high temperatures, became smaller. When the amount of added gadolinium increased from 3% by weight to 20% by weight, an equiaxed α-phase, not a needle-like shape, was generated in all cases, and its size also tended to become gradually finer as the amount of added gadolinium increased. Through the crystal orientation spatial distribution microstructure images of FIG. 5, it can be seen that in the case of the examples including gadolinium addition, the particles were expressed in various colors. This means that a preferred orientation or crystallographic texture, in which particles with a specific crystal orientation increase after transformation from the titanium β-phase to the titanium α-phase, was not developed.

Through the above-described results of FIGS. 1, 2, 3, and 5 and Tables 1and 2, it can be inferred that as the amount of added gadolinium increases, the fraction of the Gd phase and the (Gd+Gd₂O₃) composite phase increases, which causes oxygen, which serves to increase the strength and decrease the ductility in titanium and titanium alloys, to be absorbed by the gadolinium particle surface, thereby lowering the oxygen concentration in the titanium matrix. As a result, it can be seen that the elongation also increased as the gadolinium content increased up to 10% by weight (Examples 1, 2, 3 and 4). When the gadolinium content increased to more than 10% by weight (Examples 5 and 6), as the amount of the Gd₂O₃ oxide generated on the gadolinium surface increased, the interfacial bonding force between the Gd₂O₃ oxide and the titanium matrix decreased, resulting in fracture at a relatively low strain during the tensile test. However, it can be seen that even when the elongation was reduced, the ductility was much better than that of the commercial neutron absorbing material, Al-40% B₄C composite (elongation 1% to 2%).

In summary of the above-described Experimental Examples 1 to 4, it can be seen that since the neutron absorbing structural material according to the present invention can improve the low strength of the conventional Al-B₄C composite-based neutron absorbing material and exhibit superior ductility, it can simultaneously perform the function of a neutron absorbing structural material as well as the neutron absorption function. In addition, it can be seen that the neutron absorbing structural material according to the present invention can improve the problems of poor formability in the manufacturing process of Al-B₄C composite or boron-containing corrosion-resistant steel and high brittleness of finished products, and at the same time, remarkably improve the efficiency and economic efficiency of designing and manufacturing spent nuclear fuel storage facilities by not requiring a separate support or structural material, and enable the design of a spent nuclear fuel storage container with a certain volume so as to store a larger amount of spent nuclear fuel therein, thus maximizing usability in a limited space.

1. A neutron absorbing structural material alloy composition comprising:
a matrix metal; and
gadolinium (Gd) in an amount of 2% to 49% by weight based on the total weight of the matrix metal.

2. The composition of claim 1, wherein the matrix metal is titanium.

3. The composition of claim 1, wherein the neutron absorbing structural material alloy composition contains no hafnium (Hf).

4. A neutron absorbing structural material comprising:
the neutron absorbing structural material alloy composition of claim 1; and
a residual amount of oxygen;
wherein a part of the gadolinium of the neutron absorbing structural material alloy composition is dissolved in a matrix metal, and the remaining part is dispersed in the form of an α-gadolinium phase (α-Gd phase).

5. The neutron absorbing structural material of claim 4, wherein the residual amount of oxygen is less than 0.3% by weight based on the total weight of the neutron absorbing structural material.

6. The neutron absorbing structural material of claim 4, wherein the neutron absorbing structural material satisfies all of Relations 1 to 3 below:
(1) yield strength of less than 550 MPa;
(2) maximum tensile strength of less than 650 MPa; and
(3) total elongation of 22% or more.

7. A method of manufacturing a neutron absorbing structural material, comprising:
a first step of preparing the neutron absorbing structural material alloy composition of claim 1;
a second step of melting the neutron absorbing structural material alloy composition to manufacture a molten ingot;
a third step of hot-forging the molten ingot and then rolling the same to manufacture a rolled material; and
a fourth step of heat-treating the rolled material.

8. The method of claim 7, wherein the fourth step is a β-phase heat treatment step for heat-treating at a temperature higher than or equal to 900° C. and then air-cooling or water-cooling, or a recrystallization heat treatment step at a temperature lower than or equal to 900° C.
